(19) United States
(12) Patent Application Publication
(10) Pub. No.: US 2012/0055777 A1
(43) Pub. Date: Mar. 8, 2012

(54) Distillation Urine Recycling Systems and Methods

(75) Inventors: Giovanni Fima, Oceanside, CA (US); Frank Landon, Santa Ana, CA (US)

(73) Assignee: LIQUIDBREAKER LLC., Carlsbad, CA (US)

(21) Appl. No.: 12/917,967

(22) Filed: Nov. 2, 2010

Related U.S. Application Data
(60) Provisional application No. 61/379,980, filed on Sep. 3, 2010.

(51) Int. Cl. C02F 1/04; B01D 3/10

(52) U.S. Cl. 202/185.1

(57) ABSTRACT

Systems and methods for processing wastewater into a flushing fluid are described, in which wastewater flows into a holding tank from one or more restroom fixtures. A vacuum distillator can be coupled to the holding tank, and a heater can be configured to heat at least a portion of the wastewater in the vacuum distillator to produce a vapor. The vapor can be condensed by a condenser fluidly coupled to the vacuum distillator to produce a distilled stream. The stream can either be fed into a tank or passed to one or more restroom fixtures.

This application claims priority to U.S. provisional application having Ser. No. 61/379980 filed on Sep. 3, 2010. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is wastewater processing systems.

### BACKGROUND

Traditional urinals, toilets, and other urine receptacles utilize potable water to flush restroom fixtures, which amounts annually to significant quantities of water that could otherwise be consumed for drinking or other uses. This constant need for potable water can be problematic, especially in areas with limited or no access to water. To reduce the water usage of restroom fixtures, low-flush and waterless urinals and toilets are increasingly being used. With a growing emphasis on water conservation, there is heightened interest in restroom fixtures designed to minimize the amount of water used.

Various forms of waterless urinals are known that utilize cartridges having oil or other low-density sealants to prevent odors from emanating from the drain pipe. Exemplary patents include U.S. Pat. No. 5,711,037 to Reichardt et al., U.S. Pat. No. 6,053,197 to Gorges, U.S. Pat. No. 6,644,339 to Gorges et al., U.S. Pat. No. 6,959,723 to Gorges, and U.S. Pat. No. 6,973,939 to Gorges et al. These low-density sealants are problematic because they remain open to the atmosphere, which allows odors to permeate from the drain as the sealant is depleted. These cartridges also require periodic replacement, which can add significantly to the waterless urinals' cost, especially in high traffic areas.

It is known to utilize various valved systems in waterless urinals. See, e.g., U.S. Pat. No. 6,401,266 to Mitchell et al.; U.S. Pat. Appl. No. 2006/0010565 to Cummings (publ. May 2006); U.S. Pat. Appl. No. 2006/0207005 to Janssen (publ. Sept. 2006); WIPO Patent Appl. No. 2009/040524 to McAlpine (publ. April 2009); U.S. Pat. No. 6,286,153 to Keller; and U.S. Pat. No. 4,180,875 to Wilson. However, such valved systems typically retain a small amount of fluid in the valves after each use, which can cause odors to emanate from the valves. In addition, the valves are generally prone to freezing in cold regions, and sticking In addition, the systems generally utilize only a single valve, which can be problematic if the valve is stuck open due to sticking, freezing, debris, or otherwise.

To eliminate the issues found in many waterless urinals, it is known to recycle flushing water. For example, U.S. Pat. No. 3,329,974 to Belasco et al. discusses utilizing a vacuum distillation unit in a zero-gravity environment to quickly heat waste materials by apparently subjecting them to the vacuum of space. U.S. Patent Appl. No. 2006/0091083 to Lumbert discusses another water recovery system that utilizes a dehydration engine, and U.S. Pat. No. 3,127,243 to Konikoff discusses a water recovery system utilizing a combination of distillation and oxidation to produce water. In addition, the International Space Station deployed a urine recycling system (see http ://www.sciencedaily.com/releases/2008/11/081111210838 .htm). Grey water recycling systems are also known, such as the AQUS™ system by Sloan™. However, all of the systems known to applicants are generally complex and can be costly to implement and maintain, which reduces the likelihood of commercial implementation.

Thus, there is still a need for improved wastewater processing systems that reduce the need for external sources of potable water to periodically flush drains.

### SUMMARY OF THE INVENTION

The inventive subject matter provides apparatus, systems and methods in which a wastewater processing system includes a holding tank to collect wastewater, and a vacuum distillator coupled to the holding tank. At least a portion of the wastewater can be evaporated with the vacuum distillator to produce a vapor, which thereby separates water from the other components of the wastewater. Typically, the wastewater comprises urine, although the wastewater may also comprise grey water such as from sinks The vapor can be condensed through a condenser to produce a distilled stream. At least some of the distilled water can be used as a flushing liquid for one or more restroom fixtures.

As used herein, the term “restroom fixture” includes urinals, toilets, and similar urine depositories. Contemplated wastewater processing systems can be sized and configured as needed, depending on the deployment location. Contemplated systems could be used in residences, hotels, commercial buildings, and recreational vehicles, for example. Preferred systems can be fluidly coupled to at least two, more preferably at least five, and most preferably at least ten restroom fixtures, which can include urinals, or a combination of urinals and toilets. By using the system with multiple restroom fixtures, the overall ownership cost of the system can be reduced. It is contemplated that the system can advantageously be used in both new constructions and retrofit installations.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The vacuum distillator advantageously reduces the boiling temperature of the wastewater, and thereby reduces the amount of energy required to boil the wastewater. The lower boiling temperature also reduces, and can eliminate, corrosion and crystal build-up that can occur at higher temperatures. The reduced temperature further reduces the temperature gradient between the hottest and coolest points in a heat exchange circuit when used, which thereby improves the circuit's efficiency.

Contemplated systems can also include one or more ultraviolet light emitters to sanitize one or more conduits or tanks of the systems.

The wastewater processing system can produce a concentrated effluent that can be sent to a drain pipe or collected in a user-removable tank. Collecting the concentrated effluent advantageously allows the effluent to be removed from the system and processed, such that minerals and pharmaceuticals that are present in the effluent can be extracted.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIGS. 1-5 are schematics of various embodiments of systems for processing wastewater.

FIG. 6 is a diagram of yet another embodiment of a system for processing wastewater.

FIG. 7 is a diagram of an embodiment of a system for processing wastewater that is sized and dimensioned to fit underneath one or more sinks

FIG. 8 is a diagram of an embodiment of a system for processing wastewater that is sized and dimensioned for a residence.

FIG. 9 is a diagram of an embodiment of a system for processing wastewater that is sized and dimensioned for a multi-story commercial building.

FIG. 10 is a diagram of an embodiment of a system for processing wastewater that is sized and dimensioned for a single bathroom.

### DETAILED DESCRIPTION

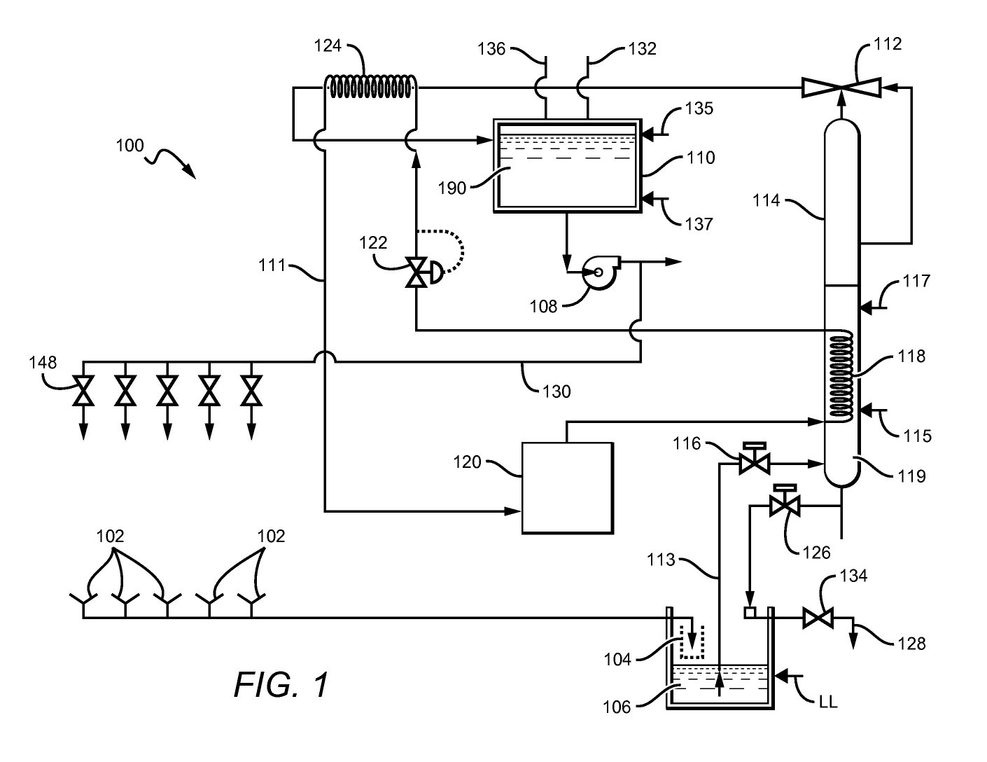

In an exemplary embodiment of a water recovery system 100 for processing wastewater into a flushing fluid shown in FIG. 1, wastewater can be piped from five urinals 102 through an optional filter 104 and into a holding tank 106. Filter 104 can be a strainer basket, a nano-electronic filter or other commercially suitable filter that advantageously removes debris and other solid contaminants from the wastewater. The wastewater can remain in the holding tank 106 until it is needed for processing. If the wastewater level in the holding tank 106 reaches a predetermined maximum level, the excess wastewater can flow from the holding tank 106 to a drain pipe 128. This can occur passively, similar to overflow holes found in sinks, or could occur actively, such as by the use of a level switch that signals a valve actuator to open a valve and allow the excess wastewater to flow to the drain pipe 128. Preferably, the drain pipe 128 includes a check-valve 134 or other one-way valve, such that backflow from the drain pipe 128 can be prevented from reaching system 100.

A vacuum distillator 114 can be fluidly coupled to the holding tank 106 by way of conduit 113 controlled by a fill valve 116. In this manner, once a predetermined level of vacuum has been produced in the vacuum distillator 114, the fill valve 116 can be opened and the vacuum can draw wastewater from the holding tank 106 into the vacuum distillator 114. Alternatively, a pump or other means could be used to move wastewater into the vacuum distillator 114. The vacuum distillator 114 can include a switch or other sensor 115 such that when the wastewater 119 reaches a predetermined level in the vacuum distillator 114, the switch or sensor 117 can send a signal causing fill valve 116 to be closed. While the vacuum distillator 114 fills, it is preferred that the drain valve 126 remain closed to ensure that the wastewater flows only into the vacuum distillator 114.

In preferred embodiments, a circulation pump 108 can be used to pump water 190 from an accumulator tank 110, through an eductor 112 and then return to the accumulator tank 110. As water flows through the eductor 112, a partial vacuum can be created in the vacuum distillator 114, which is fluidly coupled downstream of the eductor 112. Alternatively, the eductor 112 can be replaced or supplemented with a vacuum pump.

Preferably, water is pumped through the eductor 112 at a pressure of about 50 psi and a rate of about 12 gpm, although lower and higher pressures and rates are also contemplated depending on the size of the system and eductor 112 and the desired amount of vacuum. Preferably, the eductor 112 can produce at least 20 in of vacuum, more preferably, at least 22 in, and most preferably, at least 24 in of vacuum. However, the specific amount of vacuum needed will vary depending on the size of the vacuum distillator 114, the composition of the waste fluid, and so forth.

When the desired level of vacuum is obtained in the vacuum distillator 114, the heater 118 can be activated, if not already activated, to begin heating the wastewater in the vacuum distillator 114. Preferred levels of vacuum allow the wastewater in the vacuum distillator 114 to heat to no more than 130° F., and preferably approximately 120-130° F., which eliminates the possibility of crystals forming on the heater 118. One of ordinary skill in the art would of course contemplate other temperatures depending on the composition of the wastewater and the components of the system 100. The low boiling temperature reduces the energy needs of heater 118, and allows the vacuum distillator 114 to be composed of a plastic exterior rather than stainless steel or other metal or metal composites. However, any commercially suitable material(s) could be used.

Heater 118 could be an electric heater or other standalone heater, or part of a heat exchange circuit 111, such as that shown in FIG. 1. A heat exchange medium can be heated upstream of the heater 118 by compressor 120, which increases the temperature and pressure of the heat exchange medium. The heated medium can then pass through the heater 118, which heats the wastewater in the vacuum distillator 114. The heater 118 can be a series of coils or other commercially suitable heat exchanger(s). A currently preferred heat exchange medium is r134a or other commercially suitable refrigerant. Alternatively, the circuit 111 can include a solid thermally elastic metal alloy configured to absorb and release heat as needed in a heat exchange cycle.

From the heater 118, the heat exchange medium can flow through an expansion valve 122 to thereby lower the temperature of the medium. Preferably, the temperature of the medium is reduced to about 36° F., although the specific temperature can vary depending on the configuration of the system 100. Contemplated expansion valves include a Joule-Thomson valve or any other commercially suitable expander. The cooled heat exchange medium can then flow through a second heat exchanger 124, which is used to cool a distilled stream from the eductor 112 to a currently preferred temperature of about 55-60° F. From the second heat exchanger 124, the heat exchange medium can then flow to the compressor 120 to complete the circuit 111.

The heat exchange circuit 111 advantageously is configured such that the heat exchange medium can be used to heat some or all of the wastewater 119 in the vacuum distillator 114 by heat exchange, and then used to cool vapor in the condenser 112 either directly or indirectly. It is contemplated that the heat exchange medium could directly cool the vapor by heat exchange. Alternatively or additionally, the heat exchange medium can indirectly cool the vapor by cooling the distilled stream by heat exchange, and the then cooled distilled stream can then be used to condense the vapor.

It is further contemplated that the heat exchange medium can circulate within a Carnot cycle air conditioning unit. Alternatively, the heat exchange medium could be heated and cooled by another medium that circulates within a Carnot cycle air conditioning unit. In preferred embodiments, the Carnot cycle air conditioning unit is an off-the-shelf air conditioning unit, which are reliable, inexpensive, and easily replaced. However, any commercially suitable heating and cooling systems could alternatively be used. The heat exchange circuit 111 advantageously eliminates the need for separate systems for heating and cooling, reducing the complexity of the system 100, while increasing the efficiency of the system 100 to that of a heat pump.

As wastewater 119 boils in the vacuum distillator 114, vapor will be produced such that water vapor can be separated from contaminants, minerals, and other components of the wastewater 119. The vapor can flow into the eductor 112, where it can be condensed into a distilled stream by the cooled water from accumulator tank 110. Although a separate condenser could be used, the eductor 112 is preferred as it eliminates the need for an additional heat exchanger such as those used in the prior art and thereby reduces the complexity of the system 100. The distilled stream can then flow past the second heat exchanger 124 which cools the stream, and condenses any remaining vapor. Next, the cooled distilled stream can flow directly to one or more urinals 102 or other restroom fixtures via conduit 130, or can flow to the accumulator tank 110 where it is stored until needed (e.g., until flushing valves 148 are opened) to flush the urinals 102 or other restroom fixtures. In this instance, and where other upper limits are not expressly stated, the reader should infer a reasonable upper limit. In this instance, for example, a commercially reasonable upper limit is about 40 restroom fixtures.

Preferably, the distilled stream is non-potable and odorless, which is sufficient for flushing restroom fixtures. This advantageously reduces the need for multiple filters and other processing steps required to produce potable water.

Tank 110 can optionally include a high level switch or other sensor 135 such that flow to the vacuum distillator 114 can be stopped when a fluid level in the accumulator tank 110 reaches or exceeds a predetermined level. Additionally, the accumulator tank 110 can include a low level switch or other sensor 137. In this manner, when a low fluid level is detected, a signal can be sent to activate the system 100. Alternatively, or additionally, water from city water line 132 can be automatically added as needed to ensure there is sufficient flushing water in tank 110. It is preferred, however, that the system 100 lacks a direct connection to the city water line 132.

It is contemplated that the accumulator tank 110 can initially be filled with tap water either manually or through a direct, and preferably indirect, connection to the city water line 132.

The system 100 can include a vent 136 to the atmosphere, which can be used to dissipate any vacuum remaining in the vacuum distillator 114 when needed. Optionally, the accumulator tank 110, or a conduit leading to or from the tank 110, can include a charcoal or other filter or an ultraviolet light emitter.

Some or all of the system controls can be coordinated with a programmable logic controller (PLC) or other commercially suitable hardware and software. The specific hardware and software requirements will depend on the configuration of the system 100.

The system 100 can be configured to automatically shut down, and optionally sound an alarm, change a status light, or otherwise provide an alert if the holding tank 106 is empty or if the accumulator tank 110 is full. If the both tanks 106 and 110 are full, the system 100 can be set to remain off and excess effluent can be diverted to the drain pipe 128.

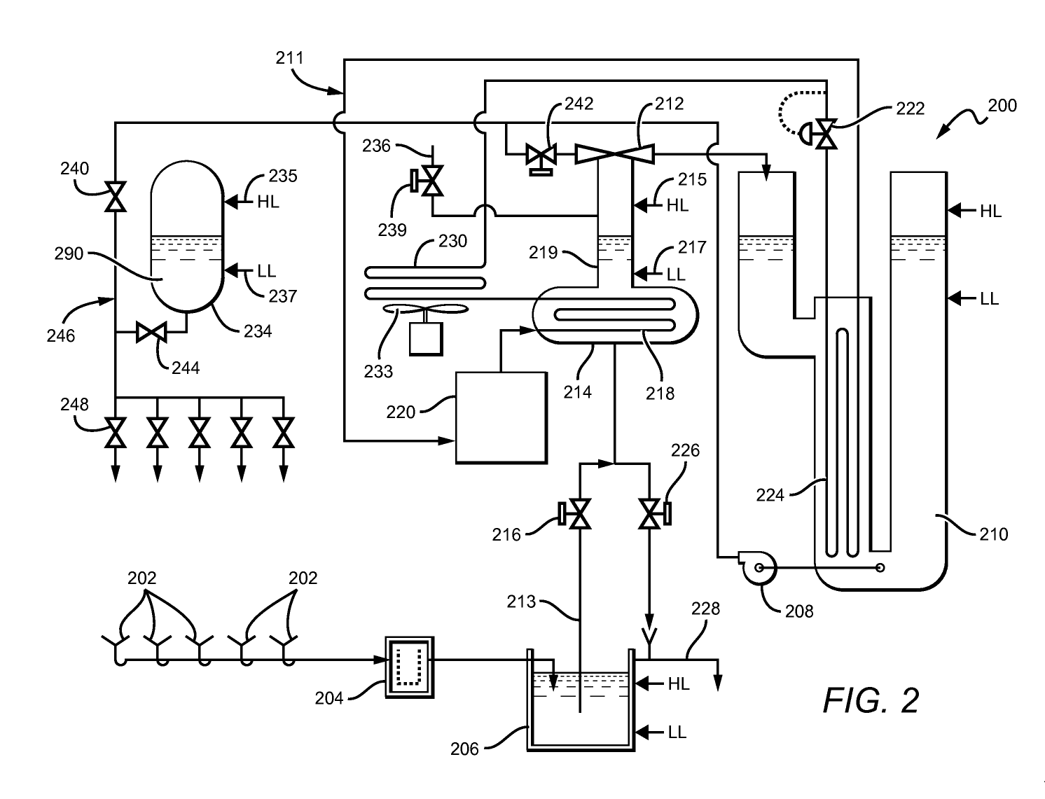

FIG. 2 illustrates another embodiment of a wastewater processing system 200. A heat exchange circuit 211 can include a third heat exchanger 230, which can cool the a heat exchange medium within circuit 211 using a fan 233 or other commercially suitable device to reject excess heat build-up from the circuit 211. Fan 233 can be controlled by a thermostatic switch (not shown) at the bottom of the cooling tank 210 or by any other commercially suitable means. Preferably, fan 233 can continue to operate while the distilled liquid in cooling tank 210 is above 36° F. and the compressor 220 is running The second heat exchanger 224 can be placed inside cooling tank 210 such that the liquid in the cooling tank 210 is cooled by the expanded heat exchange medium.

Water from the cooling tank 210 can be pumped to a bladder accumulator tank 234 by way of pump 208, which pressurizes the distilled liquid for use in flushing urinals 202. The accumulator tank 234 is beneficial as it allows additional distilled liquid 290 to be stored for later use, and can reduce the size of the system 200. Valves 240 and 242 can be used to regulate the flow of distilled liquid to and from the accumulator tank 234 and the eductor 212, and valve 244 can be used to regulate the flow of distilled liquid to the accumulator tank 234 and the urinals 202. Thus, for example, if valve 240 is closed and valve 242 is opened, at least a portion of the distilled liquid can flow to eductor 212. If valve 240 and 242 are both open, at least a portion of the distilled liquid can flow to the eductor 212 and to the conduit 246. From conduit 246, the distilled liquid can flow to urinal flush valves 248 and to the accumulator tank 234, if valve 244 is opened.

Vacuum distillator 214 can include a vent 236 that is connected to the atmosphere, and regulated by a valve 239. In this manner, when valve 239 is opened, any vacuum within the vacuum distillator 214 can be dissipated. With respect to the remaining numerals in FIG. 2, the same considerations for like components with like numerals of FIG. 1 apply.

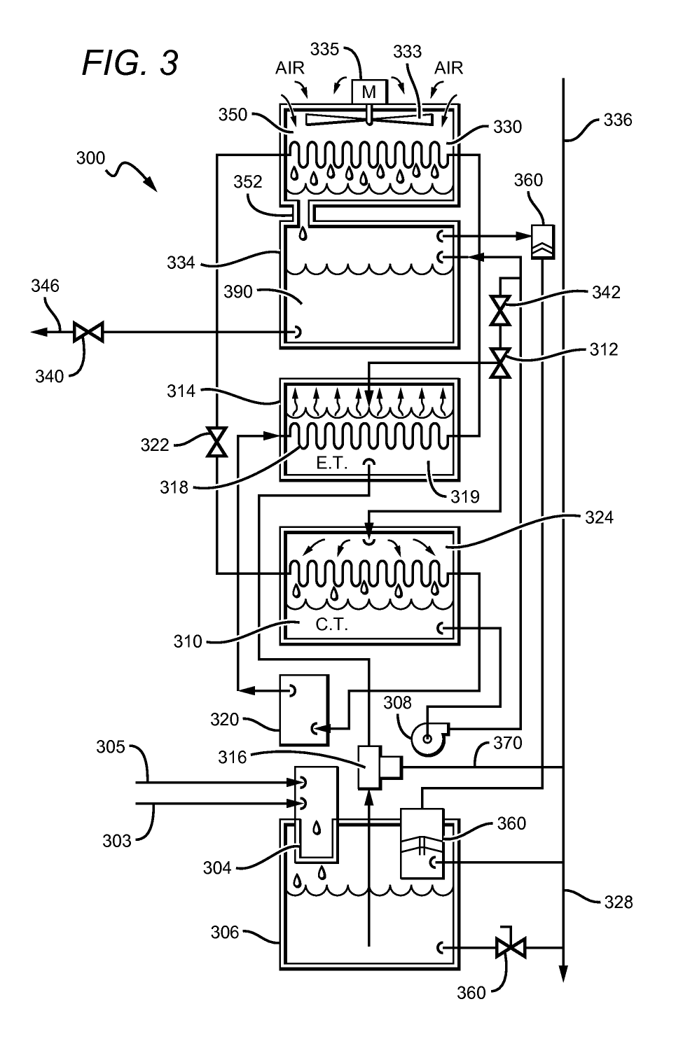

In FIG. 3, another embodiment of a system 300 for processing wastewater into a flushing fluid is shown having an air-to-water harvester 350. The heated medium from the heater 318 can flow to a second heat exchanger 330 disposed within the air-to-water harvester 350. Air can pulled into the harvester 350 by fan 333 which is powered by motor 335, and the air can then be heated by the medium in the second heat exchanger 330 to produce a water vapor. As the water vapor cools and condenses, the condensed fluid can flow into the accumulator tank 334 by way of conduit 352. The air-to-water harvester 350 could be used on an as needed basis, periodically, or otherwise. Alternatively, other commercially suitable air-to-water harvesters could be used including, for example, hygroscopic media with lithium chloride. Such a system could advantageously recover significant quantities of water from the air in a relatively short time period.

The air-to-water harvester 350 advantageously reduces the amount of moisture in the air, which can (1) reduce, if not eliminate, unpleasant odors resulting from too much moisture in the air, (2) prevent mold from building-up on walls, the floor, or other areas; and (3) minimize airborne pathogen and germs, while providing fluid for the system 300 to process.

The heat exchange medium can then flow from the second heat exchanger 330 through an expansion valve 322, which cools the medium. The cooled medium can then be used to cool a distilled stream in tank 310. As shown in FIG. 3, the system 300 can include one or more one-way valves 360, such that backflow can be prevented within the system 300. A preferred valve is that described in U.S. utility application having Ser. No. 12/765123 filed on Apr. 22, 2010, although any commercially suitable one-way valves could be used.

The system 300 can also include a conduit 370 that is fluidly coupled to vacuum distillator 314 via a three-way valve 316, although multiple two-way valves or a direct connection to vacuum distillator 314 could alternatively be used. Conduit 370 allows for flushing of vacuum distillator 314, as needed.

The system 300 can further include a wastewater conduit 303 that delivers wastewater from one or more urinals (not shown) to holding tank 306, and a grey water conduit 305 that delivers grey water from one or more sinks (not shown) to the holding tank 306. In this manner, the amount of wastewater that can be processed by the system 300 is increased. Utilizing grey water is preferable over utilizing fresh water because it can (a) reduce sewer charges, and (b) reduce the need for fresh water. With respect to the remaining numerals in FIG. 3, the same considerations for like components with like numerals of FIG. 2 apply.

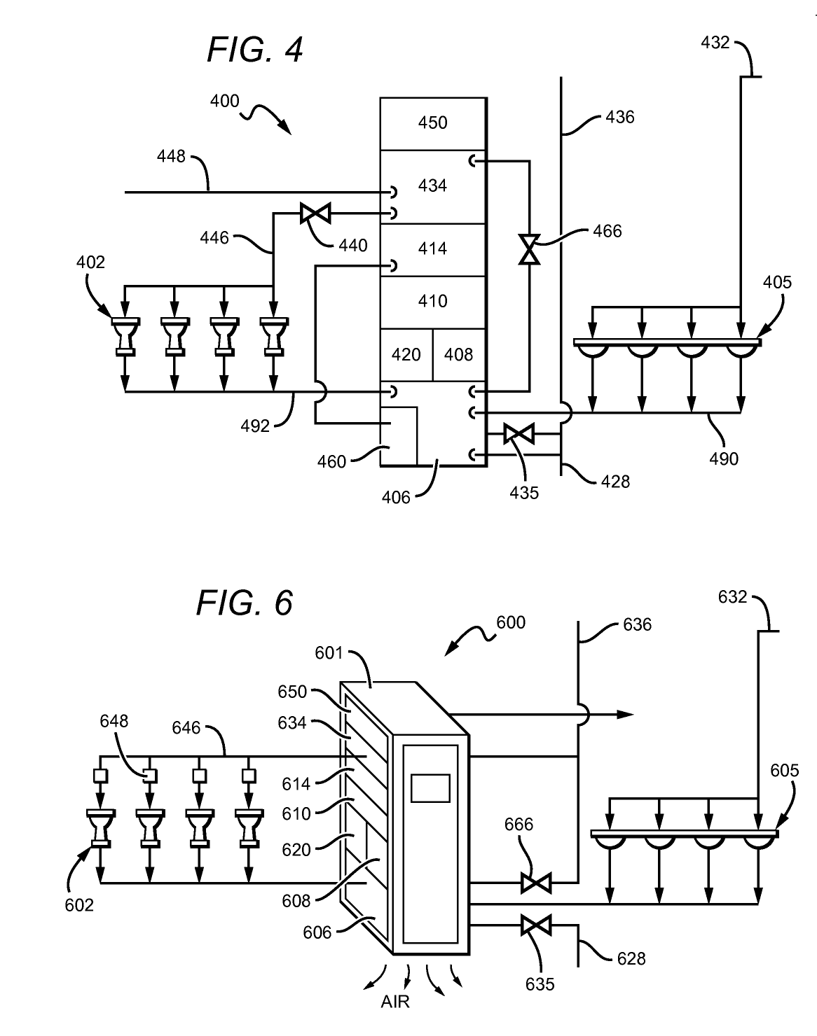

FIG. 4 illustrates yet another embodiment of a system 400 for processing wastewater into a flushing fluid, in which distilled water can flow from an accumulator tank 434 to a flush valve conduit 446 for urinals 402, and to flush tanks in toilets (not shown) via conduit 448. The system 400 can include a grey water conduit 490 that delivers grey water from sinks 405 to the holding tank 406, and a wastewater conduit 492 that delivers wastewater from urinals 402 to holding tank 406. The sinks 405 are connected to a city water line 432.

The system 400 can include a concentrated effluent tank 460 that is preferably disposed adjacent to, or within, holding tank 406. The concentrated effluent tank 460 is preferably user-removable such that the tank 460 can be emptied and cleaned, as needed. Collecting the concentrated effluent is advantageous in that minerals, pharmaceuticals, and other valuable components of the wastewater can be extracted, sold, and possibly reused.

The effluent from the wastewater can be concentrated each time the wastewater level in the vacuum distillator 414 cycles from a high level switch to a low level switch. Preferably, one cycle increases the concentration of the effluent by about 50%. Each time the low level switch in the vacuum distillator 414 is reached, a fill valve (not shown) can be opened, which allows wastewater to fill the vacuum distillator 414. Once the wastewater reaches a high level switch, the fill valve can be closed. It is contemplated that if this cycle is repeated six times, the effluent in the vacuum distillator 414 could increase in concentration by 400%, or even 600% or more, without crystallization or substantial thickening of the concentrated effluent.

When the desired amount of concentration has occurred, the vacuum in the vacuum distillator 414 can be dissipated, and the concentrated effluent can be drained through the drain valve (not shown) to the concentrated effluent tank 460, or to the sewer.

System 400 can further include one one-way valve 466, such that backflow can be prevented within the system 400. With respect to the remaining numerals in FIG. 4, the same considerations for like components with like numerals of FIG. 2 apply.

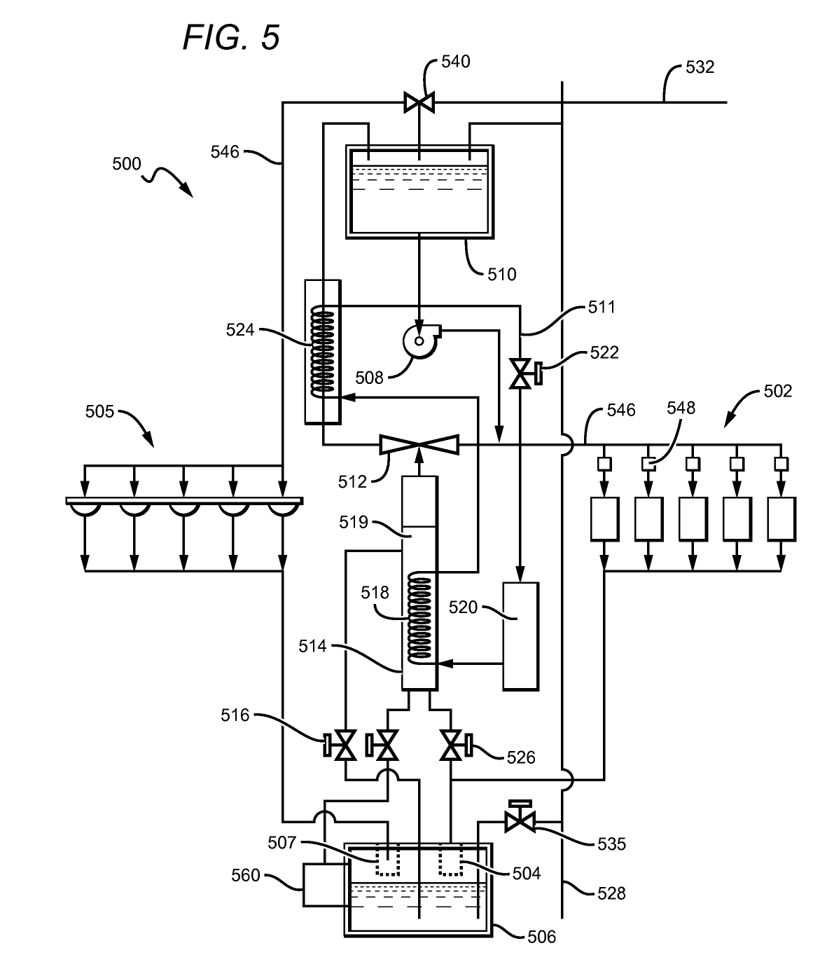

Another embodiment of a system 500 for processing wastewater 519 into a flushing fluid is shown in FIG. 5. The system 500 includes a concentrated effluent tank 560. Wastewater from urinals 502 flows into a filter 504 and into the holding tank 506. Grey water from the sinks 505 flows into a grey water filter 507 and into the holding tank 506. Preferably, the sinks 505 have valves that are automatically actuated when they detect a user, such as by the use of one or more infrared sensors. However, it is also contemplated that the sink valves could be manually actuated such as by a handle or other means.

Rather than connect the system 500 to a city water line directly, it is contemplated that sinks 505 having automatically actuated valves could be modified to include additional hardware and software, as needed, such that the valves could be actuated by the system 500. Thus, for example, if the system 500 detects that a wastewater level in the holding tank 506 is low, the system 500 could automatically actuate one or more sinks 505 such that water will flow to the holding tank 506. With respect to the remaining numerals in FIG. 5, the same considerations for like components with like numerals of FIG. 1 apply.

As shown in FIG. 6, system 600 could be contained within a housing 601 sized and dimensioned to fit between two wall studs. The components of the system 600 are preferably mounted within the housing 601 on racks (not shown), such that the components can be easily removed from the system 600 as needed for cleaning, repair, or replacement. In this sense, the components are preferably modular such that they can quickly and easily be removed, returned and/or replaced. System 600 preferably includes one one-way valve 666, such that backflow can be prevented within the system 600. With respect to the remaining numerals in FIG. 6, the same considerations for like components with like numerals of FIG. 2 apply.

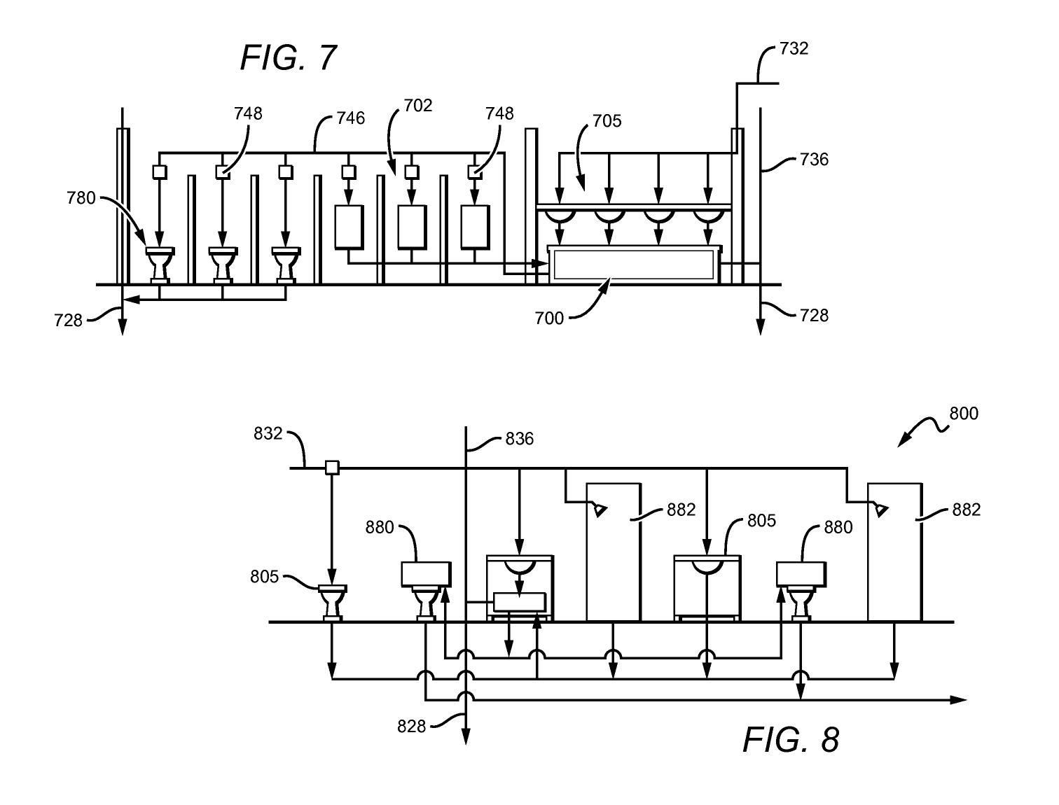

FIG. 7 illustrates an embodiment of the system 700 in which the system 700 is sized and dimensioned to be placed underneath one or more sinks 705. The system 700 can process wastewater from the sinks 705 and urinals 702 to produce a distilled stream that can be used to flush the urinals 702 and toilets 780. A city water line 732 can be fluidly coupled to the sinks 705. With respect to the remaining numerals in FIG. 7, the same considerations for like components with like numerals of FIG. 2 apply.

FIG. 8 illustrates an embodiment of the system 800 sized and configured for residential use. The system 800 can be placed under a sink 805, in a garage, or elsewhere within or outside of the home. Preferably, the system 800 is located in a central location with respect to the restroom fixtures within a home. Grey water from one or more sinks 805 and showers 882 can be mixed with wastewater from one or more urinals, if any. The wastewater can then be processed by the system 800 to produce flushing water for the toilets 880. A city water line 832 can be fluidly coupled to the sinks 805. With respect to the remaining numerals in FIG. 8, the same considerations for like components with like numerals of FIG. 2 apply.

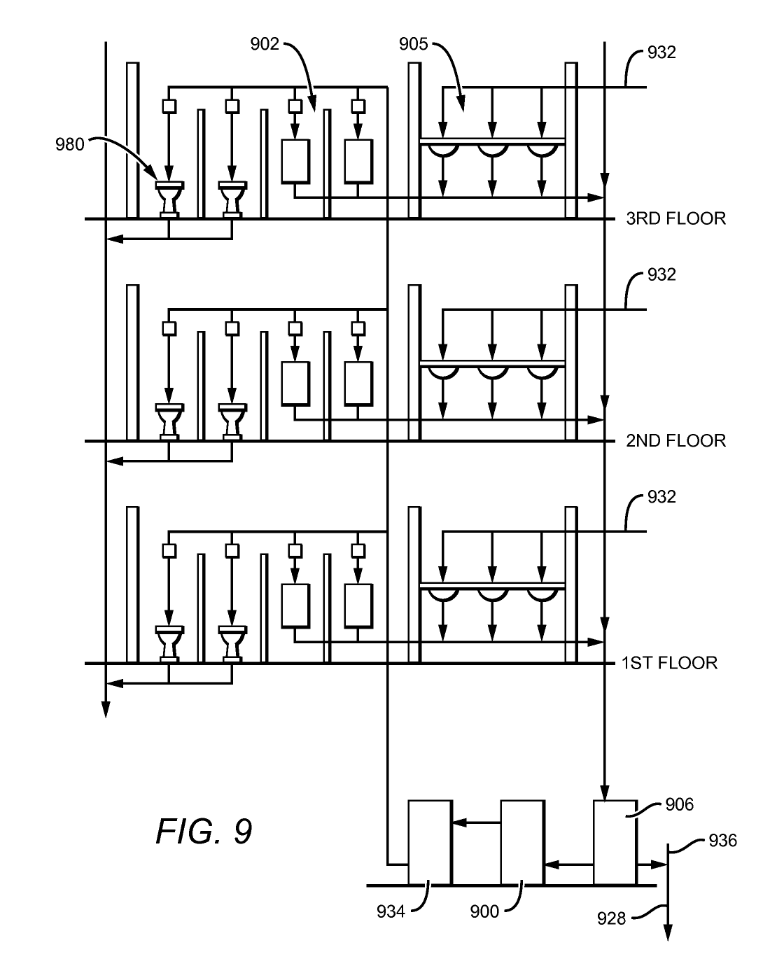

In FIG. 9, a system 900 sized and configured for commercial use is shown, in which wastewater is collected and processed from three floors of urinals 902 and sinks 905. A city water line 832 can be fluidly coupled to the sinks 805. Because of the larger number of urinals 902 and toilets 980, the system 900 includes a larger accumulator tank 934 and a larger holding tank 906. Preferably, the system 900 is located in a basement or mechanical room of the commercial building. Because the distilled water will need to flow to urinals 902 and toilets 980 on many floors, the system 900 can include one or more additional pumps (not shown) such that the distilled water is sufficiently pressurized to reach each of the toilets 980 and urinals 902. With respect to the remaining numerals in FIG. 9, the same considerations for like components with like numerals of FIG. 2 apply.

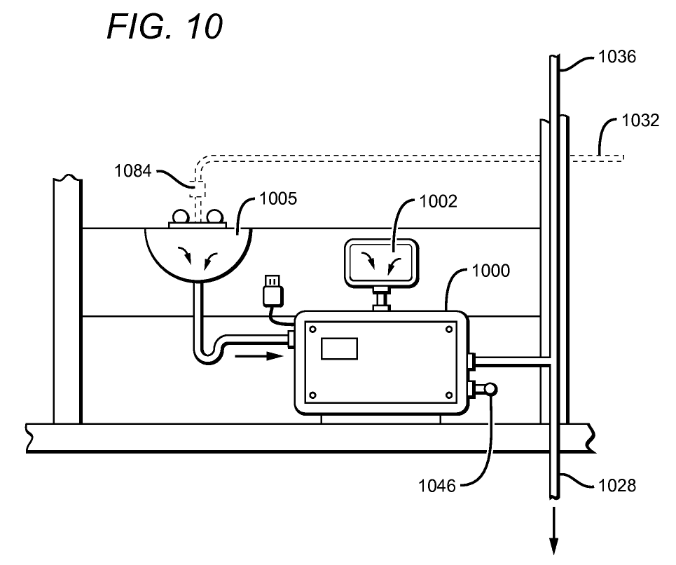

FIG. 10 illustrates another embodiment of a system 1000 for processing wastewater into a flushing fluid, which is sized and configured for a single restroom 1001, such as in a hotel room, recreational vehicle, or other restroom. A city water line 1032 can be fluidly coupled to the sink 1005. With respect to the remaining numerals in FIG. 10, the same considerations for like components with like numerals of FIG. 2 apply.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for processing wastewater into a flushing fluid for use in a restroom fixture, comprising:
a holding tank that collects the wastewater;
a vacuum distillator coupled to the holding tank;
a heater configured to heat at least a portion of the wastewater in the vacuum distillator to produce a vapor;
a condenser fluidly coupled to the vacuum distillator and configured to cool at least a portion of the vapor to produce a distilled stream; and
a conduit that passes at least some of the distilled stream to the restroom fixture.

2. The system of claim 1, wherein the condenser comprises an eductor configured to condense the vapor.

3. The system of claim 2, wherein the eductor is further configured to create a partial vacuum in the vacuum distillator.

4. The system of claim 2, wherein at least a portion of the distilled stream is passed through the eductor.

5. The system of claim 1, further comprising an accumulator tank fluidly coupled to the condenser to receive at least a portion of the distilled stream.

6. The system of claim 1, wherein a temperature of the wastewater in the vacuum distillator does not exceed 130° F.

7. The system of claim 1, further comprising an atmospheric water generator configured to produce a harvested liquid.

8. The system of claim 7, wherein the conduit is configured to pass at least some of the harvested liquid to the restroom fixture.

9. The system of claim 1, further comprising at least two restroom fixtures fluidly coupled to the conduit, and configured to receive at least a portion of the distilled stream.

10. The system of claim 9, wherein the at least two restroom fixtures comprise at least one urinal and at least one toilet.

11. The system of claim 1, wherein the wastewater comprises at least one of urine and grey water.

12. The system of claim 1, wherein the wastewater comprises urine and grey water.

13. The system of claim 1, wherein the vacuum distillator is configured to produce a concentrated effluent, and wherein the system further comprises a user-removable waste tank fluidly coupled to the vacuum distillator and configured to receive the concentrated effluent.

14. The system of claim 13, wherein the concentrated effluent comprises a pharmaceutical.

15. A commercial building comprising the system of claim 1.

16. A residence comprising the system of claim 1.

17. A recreational vehicle comprising the system of claim 1.

18. The system of claim 1, further comprising a heat exchange medium that (a) heats the portion of the wastewater in the vacuum distillator by heat exchange, and (b) cools the portion of the vapor in the condenser.

19. The system of claim 18, wherein the heat exchange medium circulates within a Carnot cycle air conditioning unit.

20. The system of claim 18, wherein the heat exchange medium directly cools the portion of the vapor by heat exchange.

21. The system of claim 18, wherein the heat exchange medium indirectly cools the portion of the vapor by heat exchange with at least a portion of the distilled stream.

22. A distillation system for distilling wastewater, comprising:
a holding tank that collects the wastewater;
a vacuum distillator coupled to the holding tank;
a first heat exchange circuit configured to heat at least a portion of the wastewater in the vacuum distillator to produce a vapor by heat exchange with a heat exchange medium;
an eductor fluidly coupled to the vacuum distillator and configured to cool at least a portion of the vapor to produce a distilled stream;
a conduit that passes at least some of the distilled stream to an accumulator tank; and
wherein the heat exchange medium cools the distilled stream in the accumulator tank by heat exchange.

23. The system of claim 22, further comprising a second conduit, in which the distilled stream can flow to a restroom fixture.

24. The system of claim 22, wherein the eductor is further configured to create a partial vacuum in the vacuum distillator.

25. The system of claim 22, wherein a temperature of the wastewater in the vacuum distillator does not exceed 130° F.

26. The system of claim 22, wherein at least a portion of the cooled distilled stream is passed through the eductor.

27. The system of claim 22, further comprising at least five restroom fixtures fluidly coupled to the conduit, and configured to receive at least a portion of the distilled stream.

28. The system of claim 22, wherein the wastewater comprises at least one of urine and grey water.

29. The system of claim 22, wherein the heat exchange medium circulates within a Carnot cycle air conditioning unit.
